(19) United States
(12) Patent Application Publication
(10) Pub. No.: US 2022/0203761 A1
(43) Pub. Date: Jun. 30, 2022

(54) WHEEL HUB ASSEMBLY APPARATUS

(71) Applicant: SMC TECHNOLOGIES PTY LTD, Port Hedland, WA (AU)

(72) Inventor: Steven Carroll, South Hedland, WA (AU)

(21) Appl. No.: 17/601,637

(22) PCT Filed: Apr. 3, 2020
(86) PCT No.: PCT/AU2020/050336

§ 371 Date: Oct. 5, 2021

(30) Foreign Application Priority Data
Apr. 5, 2019 (AU) 2019901170

(51) Int. Cl. B60B 27/00; B60C 23/04; B60C 23/00; B60C 23/12

(52) U.S. Cl. CPC B60B 27/0068; B60C 23/0486; B60C 2019/004; B60C 23/127; B60B 2900/3316; B60C 23/00318

(57) ABSTRACT

A wheel hub assembly apparatus comprising a housing configured for operative fitment to a wheel hub assembly. Also included is at least one air pressure sensor having a fluid connection for in situ fitment to tire valve and configured to selectively sense a pressure of a tire mounted on the wheel hub assembly, a temperature detector configured to detect an ambient temperature within the wheel hub assembly, a display configured to provide external display of information, and a controller arranged in signal communication with the pressure sensor, temperature detector and display, the controller configured to receive sensed pressure and/or detected temperature and to display same via the display.

### CROSS-REFERENCE TO RELATED APPLICATIONS

This application is a national phase entry under 35 U.S.C. § 371 of International Patent Application PCT/AU2020/050336, filed Apr. 3, 2020, designating the United States of America and published as International Patent Publication WO 2020/198806 A1 on Oct. 8, 2020, which claims the benefit under Article 8 of the Patent Cooperation Treaty to Australian Patent Application Serial No. 2019901170, filed Apr. 5, 2019.

### TECHNICAL FIELD

This disclosure relates generally to the field of automotive engineering, and more specifically to a wheel hub assembly apparatus, an associated a wheel hub assembly, and an associated wheeled vehicle.

### BACKGROUND

The following discussion of the background art is intended to facilitate an understanding of the present disclosure only. The discussion is not an acknowledgement or admission that any of the material referred to is or was part of the common general knowledge as at the priority date of the application.

A wheel hub assembly (WHA), also referred to as hub assembly, wheel hub unit, wheel hub bearing, etc., is an automotive part used in most cars, passenger vehicles, and light and heavy trucks. The WHA is generally located between the brake drums or discs and the drive axle. A wheel is bolted on it. Depending on the construction, the end of the hub comes equipped with splined teeth or the like that mate with complementary teeth on the axle shaft. The hub, driven from the axle, spins along with the wheels bolted to it and provide the power to the wheels in order to rotate.

Typically, a roller bearing between the axle hub and axle shaft ensures easy rotation of the non-drive wheels. On the axle side, it is mounted to a holding bracket from the vehicle chassis; on the disc side, the wheel is mounted to the bolts of the WHA.

On vehicles, such as trucks, so-called wheel separation can occur when a wheel hub assembly component becomes separated from the associated axle. Many wheel separation incidents involve disintegration of the wheel bearings and/or spindles. Typically, these separations occur as a result of improper maintenance, such as inadequate lubrication or incorrect bearing adjustment, for example. This, in turn, causes the bearings and spindle to experience elevated temperatures. During extended vehicle operation, such as cross-country truck deliveries, these temperatures can approach the melting point of the wheel end components, which will eventually cause wheel separation, tire failure, etc.

Vehicle operators have indicated that it is difficult to determine whether the wheel end components are operating at elevated temperatures. Often, wheel separation can occur with no warning to the operator. Conventionally, wheel hub assembly inspection is part of a driver's routine during stops, where the hubs are physically touched during a walkaround inspection get a sense of how hot they are running. If the hubs are warm to the touch, they are deemed to be operating within normal parameters, and if they are hot to the touch, it is assumed something is wrong.

Such conventional approaches are not ideal to determine when the wheel hub components are experiencing temperatures that exceed the normal operating range, as they are inaccurate at best and does not provide temperature indication unless the vehicle is manually inspected. The current invention was conceived with these shortcomings in mind.

### BRIEF SUMMARY

According to a first aspect of the disclosure there is provided a wheel hub assembly apparatus comprising:
a housing configured for operative fitment to a wheel hub assembly:
   a temperature detector configured to detect an ambient temperature within the hub assembly;
   a display configured to provide external display of information;
   a controller arranged in signal communication with the temperature detector and display, the controller configured to receive detected temperature and to display same via the display; and
   an energizer arrangement configured to operatively energize the temperature detector, display and controller;
wherein the temperature detector, display, controller and energizer are arranged within and/or on the housing so that displayed temperature is visible external to the hub.

Typically, the apparatus includes at least one pressure sensor having a fluid connection for in situ fitment to a tire valve and configured to selectively sense a pressure of a tire mounted on the wheel hub assembly.

In such an embodiment, the controller is arranged in signal communication with the pressure sensor and configured to receive sensed pressure for display via the display.

Typically, the pressure sensor, temperature detector, display, controller and/or energizer arrangement are arranged within and/or on the housing so that an inertial axis of the apparatus substantially corresponds with a geometric axis thereof to allow balanced angular rotation when in use.

The skilled addressee is to appreciate that rotational unbalance of a mass is generally the uneven distribution of mass around an axis of rotation. A rotating mass, or rotor, is said to be out of balance when its center of mass (inertial axis) is out of alignment with the center of rotation (geometric axis).

Typically, the housing defines a protruding bolt configured for operative placement through a suitable aperture in a hub cap or covering of a wheel hub assembly, a suitable nut threadedly engaging the bolt to secure the housing to the wheel hub assembly.

Typically, the temperature detector is operatively located proximate the bolt and/or nut to detect an ambient temperature within the hub assembly.

In an embodiment, the temperature detector is included within the bolt or nut.

Typically, the temperature detector comprises a thermistor.

In an embodiment, the housing, bolt and/or nut is magnetized to facilitate attraction of magnetic filings within the wheel hub assembly.

Typically, the fluid connection for in situ fitment to a tire valve includes an air hose with tire valve engager, or the like.

In an embodiment, the apparatus includes an inflation valve arrange in fluid communication with the fluid connection to facilitate inflation of a tire.

Typically, the controller incudes any suitable microcontroller configured to accept input, perform arithmetic and logic functions, deliver output and includes memory registers.

Typically, the controller is configured to receive user input that determines a manner in which information is displayed via the display.

Typically, the display is selected from a non-exhaustive group consisting of a light emitting diode (LED) display, a liquid crystal display (LCD), an e-ink display, and a plasma display.

In an embodiment, the display includes one or more light emitters, such as LEDs, with the controller configured to actuate the light emitters when the temperature detector detects a predetermined temperature and/or pressure.

Typically, the housing comprises a ruggedized housing to protect housed components against shock, ingress of dirt and/or liquids, etc.

Typically, the apparatus includes a wireless transmitter arranged in signal communication with the controller and configured to transmit information to a remote location.

Typically, the transmitted information is selected from a non-exhaustive group consisting of sensed pressure, detected hub temperature and energizer status.

In an embodiment, the apparatus includes a remote receiver for receiving the transmitted information and a secondary display for displaying such transmitted information.

Typically, the remote receiver and secondary display are operatively arranged within a cabin or cab of a vehicle.

In an embodiment, the remote receiver and secondary display comprise a mobile phone handset configured by means of a suitable application or “app” to receive and display the transmitted information.

Typically, the energizer arrangement comprises at least one electrochemical cell.

In an embodiment, the energizer arrangement includes a photovoltaic cell arranged to receive solar energy for charging the electrochemical cell with electrical energy.

In an embodiment, the energizer arrangement includes an energy harvesting arrangement configured to harvest and convert rotational energy into electrical energy as the apparatus rotates with the wheel hub assembly.

According to a second aspect of the disclosure there is provided a wheel hub assembly of a vehicle fitted with apparatus in accordance with the first aspect of the disclosure.

According to a third aspect of the disclosure there is provided a wheeled vehicle having at least one wheel hub assembly fitted with apparatus in accordance with the first aspect of the disclosure.

### BRIEF DESCRIPTION OF THE DRAWINGS

The description will be made with reference to the accompanying drawings in which:

FIG. 1 is a diagrammatic perspective exploded view representation of an embodiment of a wheel hub assembly apparatus in accordance with an aspect of the present disclosure;

FIG. 2 is a diagrammatic perspective view representation of the wheel hub assembly apparatus of FIG. 1 operatively fitted to a wheel hub assembly;

FIG. 3 is diagrammatic side view representation of the wheel hub assembly of FIG. 2 showing the wheel hub assembly apparatus of FIG. 1 operatively fitted thereto; and

FIGS. 4a to 4f are diagrammatic front, rear, side, perspective and sectional representations of another example of an embodiment of a wheel hub assembly apparatus in accordance with an aspect of the present disclosure.

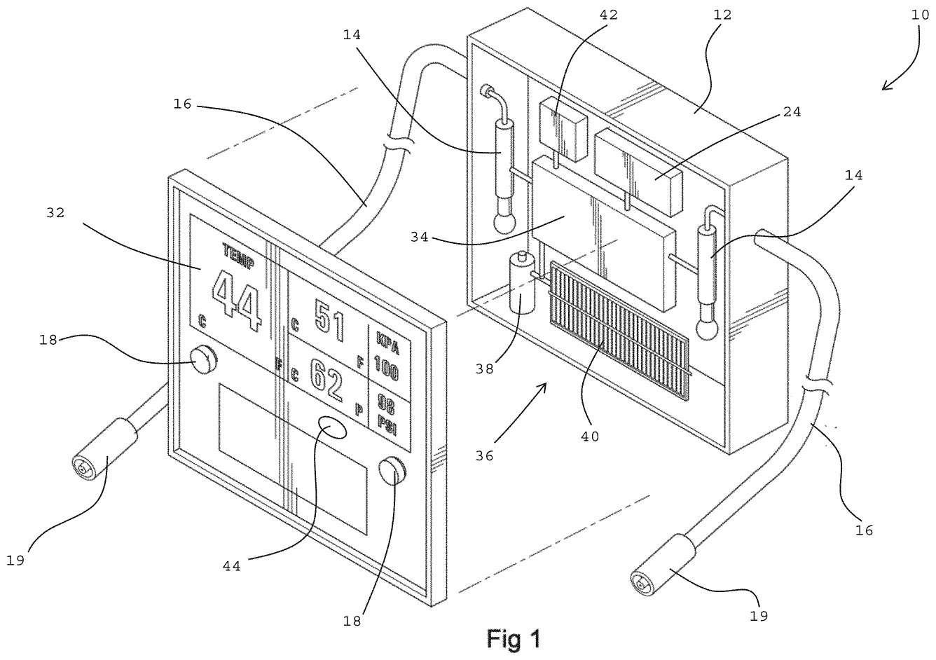

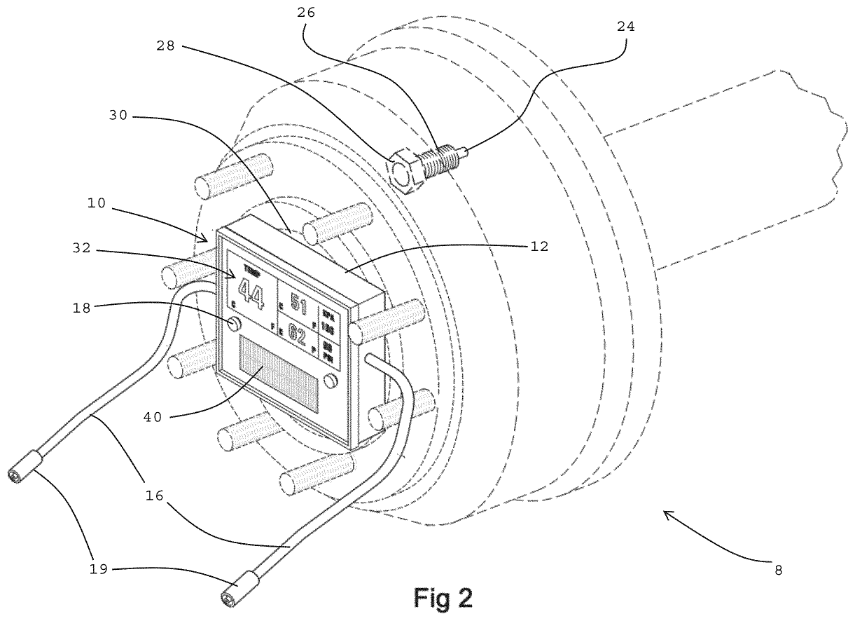

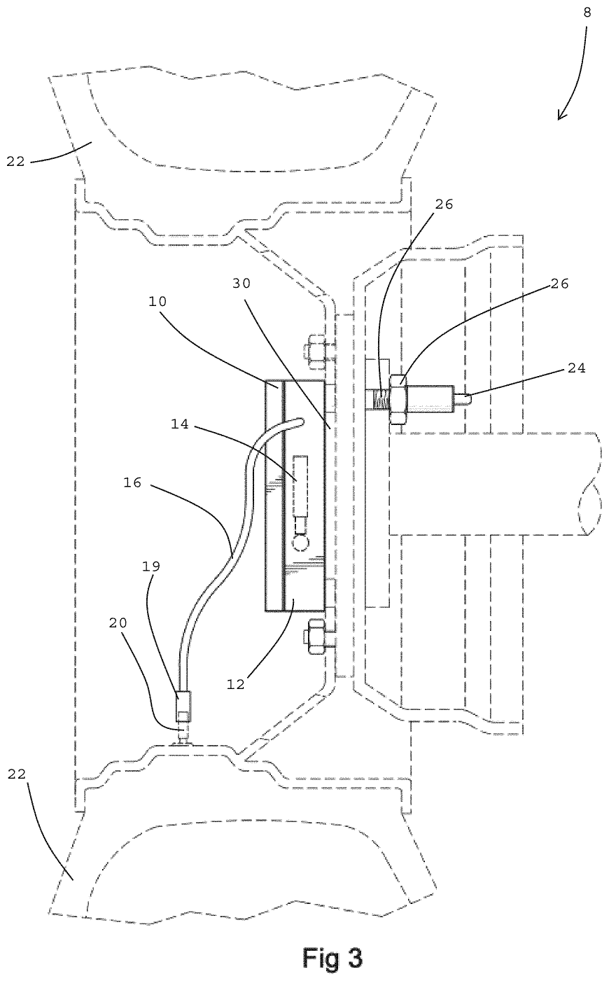

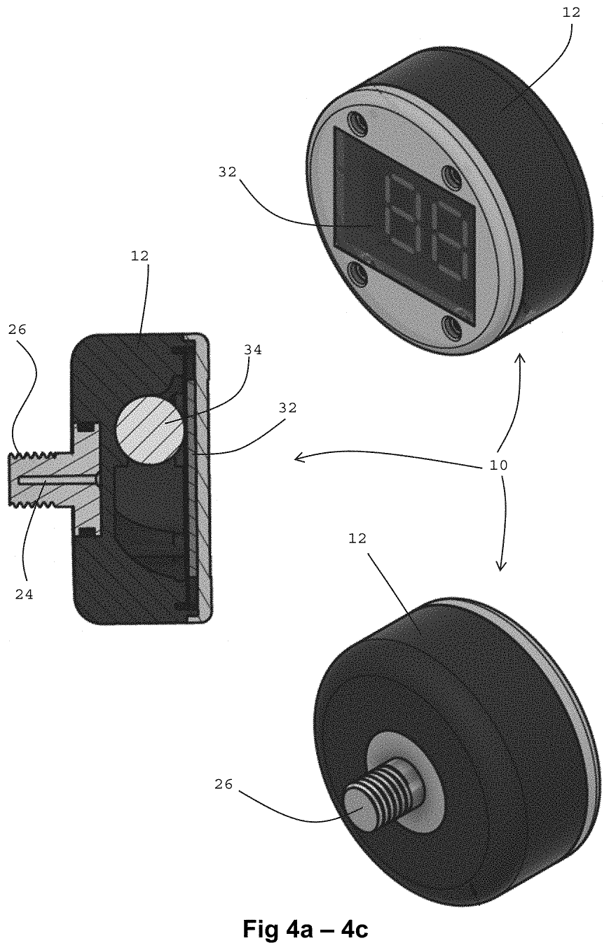

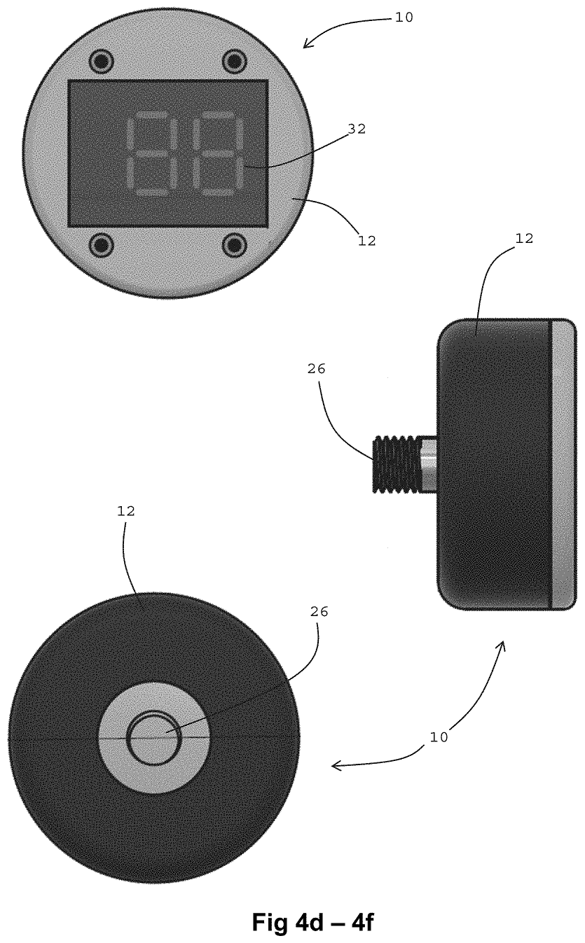

### DETAILED DESCRIPTION

Further features of the present disclosure are more fully described in the following description of several non-limiting embodiments thereof. This description is included solely for the purposes of exemplifying the present disclosure to the skilled addressee. It should not be understood as a restriction on the broad summary, disclosure or description of the disclosure as set out above. In the figures, incorporated to illustrate features of the example embodiment or embodiments, like reference numerals are generally used to identify like parts throughout.

With reference now to the accompanying drawings, there is broadly shown one possible example of wheel hub assembly apparatus 10 for operative fitment to a wheeled vehicle's wheel hub assembly 8, as is known in the art. Wheel hub assembly apparatus 10 typically comprises a housing 12, at least one air pressure sensor 14, a temperature detector 24, a display 32, and controller 34.

Accordingly, wheel hub assembly apparatus 10 includes housing 12, which is configured for operative fitment to a wheel hub assembly 8. The housing 12 generally comprises a ruggedized housing to protect housed components against shock, ingress of dirt and/or liquids, etc. In one example, housing 12 may be manufactured from a suitable polymer material, or the like. Other examples are possible and within the scope of the present disclosure.

In the exemplified embodiment, wheel hub assembly apparatus 10 includes at least one air pressure sensor 14 generally having a fluid connection 16 for in situ fitment to a tire valve 20, such as air hose 16 with tire valve engager 19, as shown. Wheel hub assembly apparatus 10 generally includes an inflation valve 18 arranged in fluid communication with the fluid connection 16 to facilitate inflation of a tire 22, or the like. In addition, air pressure sensor 14 is configured to selectively sense a pressure of a tire 22 mounted on the wheel hub assembly 8, as shown. In this manner, a tire 22 can be pressure monitored and inflated via wheel hub assembly apparatus 10.

Wheel hub assembly apparatus 10 also includes a temperature detector 24, which is configured to detect an ambient temperature within the wheel hub assembly 8. The temperature detector 24 may include a thermistor, or the like. In the exemplified embodiment, the housing 12 defines a protruding bolt 26, which is configured for operative placement through a suitable aperture in a hub cap or covering 30 of wheel hub assembly 8, as shown. Similarly, a suitable nut 28 threadedly engages the bolt 26 to secure the housing 12 to the wheel hub assembly 8.

Typically, the temperature detector 24 is operatively located proximate the bolt 26 and/or nut 28 to detect an ambient temperature within the wheel hub assembly 8. In an embodiment, the temperature detector 24 may be included within the bolt 26 or nut 28, or the like.

Wheel hub assembly apparatus 10 further includes a display 32, which is configured to provide external display of information. Such a display 32 may take a variety of forms, such as a light emitting diode (LED) display, a liquid crystal display (LCD), an e-ink display, a plasma display, a 7-segment digital display, or the like. In one embodiment, the display 32 includes one or more light emitters 44, such as LEDs, with the controller 34 configured to actuate the light emitters 44 when the temperature detector 24 detects a predetermined temperature. For example, such LEDs or light emitters 44 can be used for easy visual inspection during dark conditions, e.g., night time. The skilled addressee will appreciate that variations hereon are possible and within the scope of the present disclosure.

In addition, wheel hub assembly apparatus 10 includes a controller 34, which is arranged in signal communication with the air pressure sensor 14, temperature detector 24 and display 32, the controller 34 configured to receive sensed pressure and/or detected temperature and to display same via the display 32. The controller 34 may include any suitable microcontroller configured to accept input, perform arithmetic and logic functions, deliver output and includes memory registers. Accordingly, controller 34 is typically configured to receive user input via a suitable button or the like, which determines a manner in which information is displayed via the display, e.g., units of pressure and temperature can be changed, temperature or pressure readings may be saved, etc.

Wheel hub assembly apparatus 10 generally also includes an energizer arrangement 36 that is configured to operatively energize the air pressure sensor 14, temperature detector 24, display 32 and controller 34. Typically, the energizer 36 comprises at least one electrochemical cell 38, or a plurality to form a battery, and a photovoltaic cell 40 arranged to receive solar energy for charging the electrochemical cell 38 with electrical energy. The energizer arrangement 36 can also include an energy harvesting arrangement configured to harvest and convert rotational energy into electrical energy as the wheel hub assembly apparatus 10 rotates with the wheel hub assembly 8.

In this manner, the air pressure sensor 14, temperature detector 24, display 32, controller 34 and energizer 36 are arranged within and/or on the housing 12 so that displayed pressure and/or temperature are visible external to the wheel hub assembly 8. In one embodiment, the air pressure sensor 14, temperature detector 24, display 32, controller 34 and energizer arrangement 36 are arranged within and/or on the housing 12 so that an inertial axis of the wheel hub assembly apparatus 10 substantially corresponds with a geometric axis thereof to allow balanced angular rotation when in use. This prevents unbalanced rotation that may damage wheel hub assembly apparatus 10 and/or introduce imbalance to the wheel hub assembly 8.

In one embodiment, the housing 12, bolt 26 and/or nut 28 may be magnetized to facilitate attraction of magnetic filings within the wheel hub assembly 8. Such magnetic filings may result from normal wheel hub assembly operation, as is known in the art, and may lead to damage to the wheel hub assembly 8. As such, by wheel hub assembly apparatus 10 including some magnetized elements, such filings may be isolated to prevent WHA damage or improve WHA longevity.

In an embodiment, the wheel hub assembly apparatus 10 also includes a wireless transmitter 42 that is arranged in signal communication with the controller 34 and is configured to transmit information to a remote location. Such transmitted information can include sensed pressure, detected hub temperature and energizer arrangement status, or the like. In an embodiment, the wheel hub assembly apparatus 10 further includes a remote receiver (not shown) for receiving the transmitted information and a secondary display (not shown) for displaying such transmitted information. Typically, the remote receiver and secondary display are operatively arranged within a cabin or cab of a vehicle to allow an operator thereof to remotely monitor WHA temperature and/or tire pressure. For example, the remote receiver and secondary display may include a mobile phone of a driver that has been configured by means of a suitable application or “app” to receive and display the transmitted information.

The skilled addressee is to appreciate that the present disclosure extends to include a wheel hub assembly 8 of a vehicle fitted with wheel hub assembly apparatus 10, as well as to a wheeled vehicle (not shown) having at least one wheel hub assembly 8 fitted with such wheel hub assembly apparatus 10.

Applicant believes is particularly advantageous that the present disclosure provides for wheel hub assembly apparatus 10 whereby a temperature of a wheel hub assembly 8 may be easily and accurately monitored at a glance from proximate a wheel fitted to such wheel hub assembly 8.

Optional embodiments of the present disclosure may also be said to broadly consist in the parts, elements and features referred to or indicated herein, individually or collectively, in any or all combinations of two or more of the parts, elements or features, and wherein specific integers are mentioned herein that have known equivalents in the art to which the disclosure relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a,” “an,” “said,” “the,” and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It is to be appreciated that reference to “one example” or “an example” of the disclosure, or similar exemplary language (e.g., “such as”) herein, is not made in an exclusive sense. Various substantially and specifically practical and useful exemplary embodiments of the claimed subject matter are described herein, textually and/or graphically, for carrying out the claimed subject matter.

Accordingly, one example may exemplify certain aspects of the disclosure, whilst other aspects are exemplified in a different example. These examples are intended to assist the skilled person in performing the disclosure and are not intended to limit the overall scope of the disclosure in any way unless the context clearly indicates otherwise. Variations (e.g., modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

Any method steps, processes, and operations described herein are not to be construed as necessarily requiring their performance in the particular order discussed or illustrated, unless specifically identified as an order of performance. It is also to be understood that additional or alternative steps may be employed.

1. A wheel hub assembly apparatus comprising:
a housing configured for operative fitment to a wheel hub assembly;
a temperature detector configured to detect an ambient temperature within the wheel hub assembly;
a display configured to provide external display of information;
a controller arranged in signal communication with the temperature detector and the display, the controller configured to receive detected temperature and to display same via the display; and
an energizer arrangement configured to operatively energize the temperature detector, display and controller;
wherein the temperature detector, the display, the controller, and the energiser are arranged within and/or on the housing so that an inertial axis of the wheel hub assembly apparatus substantially corresponds with a geometric axis thereof to allow balanced angular rotation of the apparatus when in use, the display arranged within and/or on the housing so that displayed temperature is visible external to the hub.

2. The wheel hub assembly apparatus of claim 1, further comprising at least one pressure sensor having a fluid connection for in situ fitment to tire valve and configured to selectively sense a pressure of tire mounted on the wheel hub assembly.

3. The wheel hub assembly apparatus of claim 2, wherein the controller is arranged in signal communication with the pressure sensor and is configured to receive sensed pressure for display via the display.

4. (canceled)

5. The wheel hub assembly apparatus of claim 1, wherein the housing includes a protruding bolt arranged on the internal axis and configured for operative placement through an aperture in a hub cap or covering of a wheel hub assembly, a nut threadedly engageable with the bolt to secure the housing to the wheel hub assembly.

6. The wheel hub assembly apparatus of claim 5, wherein the temperature detector is operatively located proximate one or more of the bolt and the nut to detect an ambient temperature within the wheel hub assembly.

7. The wheel hub assembly apparatus of claim 5, wherein the temperature detector is included within the bolt or the nut.

8. (canceled)

9. The wheel hub assembly apparatus of claim 5, wherein one or more of the housing, the bolt, and the nut is magnetized to facilitate attraction of magnetic filings within the wheel hub assembly.

10. (canceled)

11. (canceled)

12. (canceled)

13. (canceled)

14. The wheel hub assembly apparatus of claim 1, wherein the display includes one or more light emitters, the controller configured to actuate the light emitters when the temperature detector detects one or more of a predetermined temperature and a predetermined pressure.

15. (canceled)

16. The wheel hub assembly apparatus of claim 1, further comprising a wireless transmitter arranged in signal communication with the controller and configured to transmit information to a remote location, the transmitted information selected from a group comprising sensed pressure, detected hub temperature, and energizer arrangement status.

17. (canceled)

18. The wheel hub assembly apparatus of claim 16, further comprising a remote receiver for receiving the transmitted information and a secondary display for displaying such transmitted information.

19. The wheel hub assembly apparatus of claim 18, wherein the remote receiver and the secondary display are operatively arranged within a cabin or cab of a vehicle.

20. The wheel hub assembly apparatus of claim 18, wherein the remote receiver and the secondary display comprise a mobile phone handset configured by means of an application to receive and display the transmitted information.

21. The wheel hub assembly apparatus of claim 1, wherein the energizer arrangement comprises at least one electrochemical cell and a photovoltaic cell arranged to receive solar energy for charging the electrochemical cell with electrical energy.

22. (canceled)

23. The wheel hub assembly apparatus of claim 1, wherein the energizer arrangement includes an energy harvesting arrangement configured to harvest and convert rotational energy into electrical energy as the apparatus rotates with the wheel hub assembly.

24. (canceled)

25. A wheeled vehicle having at least one wheel hub assembly fitted with the wheel hub assembly apparatus of claim 1.
